(19) United States
(12) Patent Application Publication
(10) Pub. No.: US 2024/0079826 A1
(43) Pub. Date: Mar. 7, 2024

(54) SINGLE PAIR ETHERNET CONNECTOR SYSTEM WITH INTEGRATED EXTERNAL NOISE ISOLATION

(71) Applicant: Leviton Manufacturing Co., Inc., Melville, NY (US)

(72) Inventors: Jeffrey Alan Poulsen, Bothell, WA (US); Robert Talich, Bothell, WA (US)

(21) Appl. No.: 17/929,078

(22) Filed: Sep. 1, 2022

(51) Int. Cl. H01R 13/6471; H01R 24/64

(52) U.S. Cl. CPC H01R 13/6471; H01R 24/64; H01R 2201/04

(57) ABSTRACT

A cable connector is designed to suppress at least a portion of energy that radiates from the signal contacts within the connector itself, and also reduces the effects of electrical interference from either other pairs in nearby connectors or other electrical sources. This is accomplished by grounding the connector's two outermost electrical contacts, thereby providing a path to ground between the signal contacts within the connector itself and any outside elements, including other signal pairs within other nearby connectors. To further improve signal integrity, the spacing between the connector's contacts can be selected such that the impedance of the connector substantially matches that of the cable terminated by the connector, thereby reducing return loss.

### TECHNICAL FIELD

The disclosed subject matter relates generally to copper cable connectors, e.g., a single pair ethernet connector system with integrated external noise isolation.

### BACKGROUND

Single pair ethernet (SPE) is gaining popularity as a cabling standard for delivering data and power in such applications as industrial automation systems, automotive systems, Internet of Things networking, or other applications that do not require the higher data speeds that can be achieved by multi-pair ethernet. SPE cables comprise a single pair of signal conductors as opposed to multiple twisted pairs as used in other ethernet standards, and as such offer reliable data connectivity using a smaller cable diameter. SPE cables also support power over data line (PoDL), making SPE a suitable standard for providing both data connectivity and power to end devices.

Unless properly shielded, the pair of conductors within the cable may experience electrical interference from either other pairs in nearby cables (alien crosstalk) or from other electrical noise sources. This electrical noise can be induced onto the pair, adding to the intended signal already residing on the pair, and may potentially introduce transmission errors. Similarly, pairs within data cable connectors may also experience electrical interference from either other pairs in nearby connectors (alien crosstalk) or from other electrical sources unless countermeasures are employed. For example, a shield may be strategically positioned between the connectors or between a connector and any noise source to mitigate the effects of the external noise. Alternatively, a full shield may be added to the perimeter of each individual connector.

The above-described deficiencies of connector systems are merely intended to provide an overview of some of the problems of current technology and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein relate to a SPE connector system comprising SPE connectors—including a SPE plug, a SPE jack and a SPE coupler—whose pair experiences reduced levels of coupled electrical interference from either other pairs in nearby connectors or from other electrical sources, compared to other types of connectors, without having to employ overall shields on the connectors. In one or more embodiments, the SPE plug, SPE jack and SPE coupler can each comprise four electrical contacts disposed in a 4P4C (4 position 4 conductor)—also called RJ22 (Registered Jack 22)—type contact arrangement and have a corresponding 4P4C/RJ22 form factor body. The two middle contacts of the subject connectors serve as the signal pair. Unlike conventional 4P4C/RJ22 connectors, in which the two outermost contacts serve as a second signal pair, the two outermost contacts of the subject connectors are connected to system ground, either directly, (when used as an equipment connector), via the cables to which the connectors are attached, or via other compatible-mated connector contacts. Connecting the two outermost contacts to system ground in this manner causes these contacts to absorb or suppress at least a portion of energy that radiates from the signal contacts within the connector itself, and also reduces the effects of electrical interference from either other pairs in nearby connectors or any other electrical sources. To further improve signal integrity, spacing between the connector's contacts can be selected to improve impedance matching between the SPE connectors and the cable associated with the connector system. While the present disclosure illustrates and describes these concepts within the context of a 4P4C/RJ22 connector system format, the principles described herein may be applied to any similar type of connector system whose connectors have similarly arranged contacts.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a front-end view of an example four-position four-conductor (4P4C/RJ22) type plug.

FIG. 2 is a front-end view of an example SPE plug.

FIG. 3a is a side view of an example SPE plug body.

FIG. 3b is a top view of the example SPE plug body.

FIG. 4a is a perspective view of an SPE plug inserted into a PCB mountable SPE jack.

FIG. 4b is another view of the SPE plug inserted into the PCB mountable SPE jack with the jack's body made transparent to allow the internal electrical connections to be seen.

FIG. 4c is a perspective view of the SPE plug inserted into a cable mountable SPE jack.

FIG. 4d is another view of the SPE plug inserted into the cable mountable SPE jack with the jack's body made transparent to allow the internal electrical connections to be seen.

FIG. 5 is a front view of a portion of a patch panel or other multi-port device in which three mated SPE plugs/SPE jacks are positioned adjacent to each other.

FIG. 6 is a top view of an example SPE plug having varied contact spacings.

FIG. 7a is a side view of an example SPE jack designed to accommodate a SPE plug having varied contact spacings.

FIG. 7b is a front view of the example SPE jack designed to accommodate the SPE plug having varied contact spacings.

FIG. 8a is an end view of an example SPE coupler that can be used to communicatively couple two SPE plugs.

FIG. 8b is a side view of the example back-to-back SPE coupler that can be used to communicatively couple two SPE plugs.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

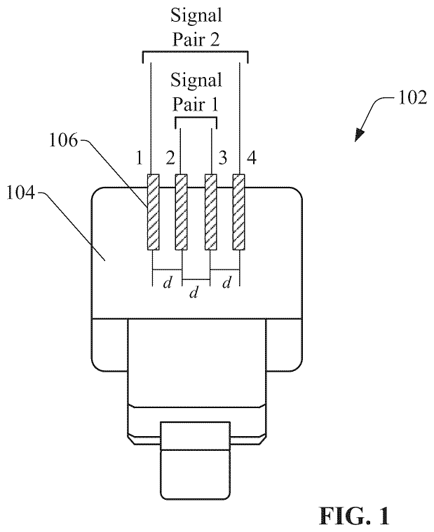

FIG. 1 is a front-end view of an example four-position four-conductor 4P4C/RJ22 connector 102. This type of connector 102 is often used to terminate spiraled/retractable patch cords such as those used to electrically connect a telephone's handset to the telephone's base. Connector 102 comprises a connector body 104 in which are mounted a row of four electrically conductive contacts 106 equally spaced from one another by a distance d. Connector 102 can be terminated to an end of a cable such that the four conductors that make up the cable's two signal pairs are electrically connected to the four contacts 106, respectively, within the connector body 104.

In accordance with 4P4C/RJ22 connectivity standards, the conductors of the 4P4C cable are typically terminated within the connector 102 such that the conductors of one signal pair (Signal Pair 1) are terminated on the two middle contacts 2 and 3, while the conductors of the other signal pair (Signal Pair 2) are terminated on the two outermost contacts 1 and 4. In the example telephone use case, the two signal pairs may correspond to the speaker and microphone signals, respectively.

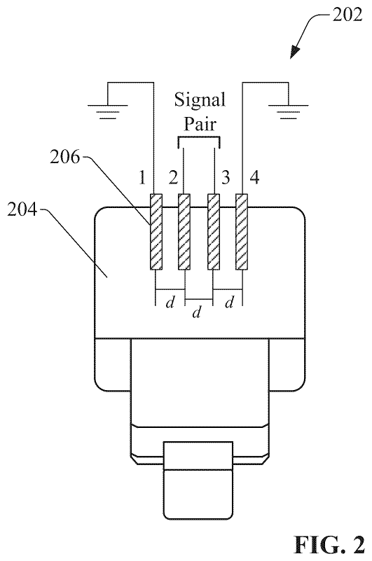

One or more embodiments of the SPE plug described herein can be based on a modified 4P4C/RJ22 style plug. FIG. 2 is a front-end view of an example SPE plug 202 according to one or more embodiments. In contrast to the two-pair connector 102 illustrated in FIG. 1, SPE plug 202 and its corresponding SPE jack (to be described in more detail herein) are configured such that the two conductors of the SPE cable's signal pair are electrically connected to the two middle contacts 2 and 3 of the SPE plug 202, and the two outermost contacts 1 and 4 of the SPE plug are connected to system ground via the cable's shield, which is typically employed in SPE cables, and/or via corresponding contacts 1 and 4 of the SPE jack that the plug is mated with. Contacts 1 and 4 thus act as a shield that absorbs or suppresses at least a portion of the energy that radiates from the two signal pair contacts 2 and 3 while data signals are propagating through the SPE plug 202, preventing this energy from interfering with contacts of adjacent, or otherwise proximate, SPE connectors, cables, or other external circuit elements. In some embodiments, the SPE plug 202 can be configured such that the two outermost contacts 206 (contacts 1 and 4) are individually electrically connected to the shield of the cable terminated with the SPE plug 202. The two outermost contacts 206 of the SPE plug may also be electrically connected together within the SPE plug 202, and then connected to the cable's shield via a single wire connection.

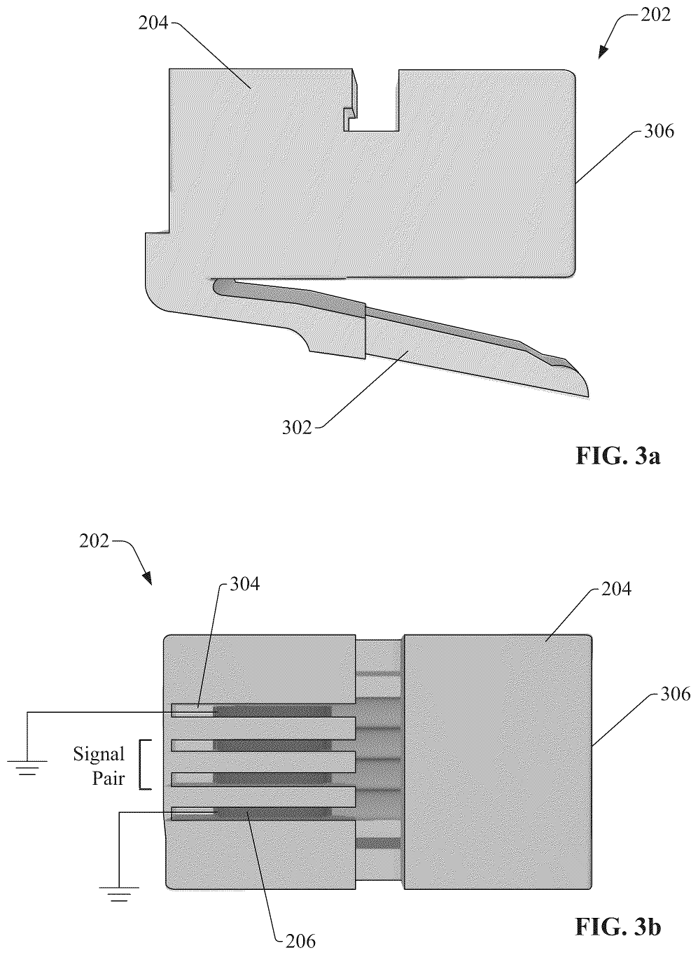

FIG. 3a is a side view of an example connector body 204 within which the SPE plug 202 can be embodied. FIG. 3b is a top view of the example connector body 204. A cable can be inserted into the back end 306 of the SPE plug 202 and individual conductors of the cable can be terminated on respective contacts 206 of the SPE plug 202. Specifically, the two conductors of the cable's signal pair can be terminated on the two middle contacts (labeled “Signal Pair” in FIG. 3b) of the SPE plug, while the two outermost contacts of the SPE plug can be connected to the cable's shield.

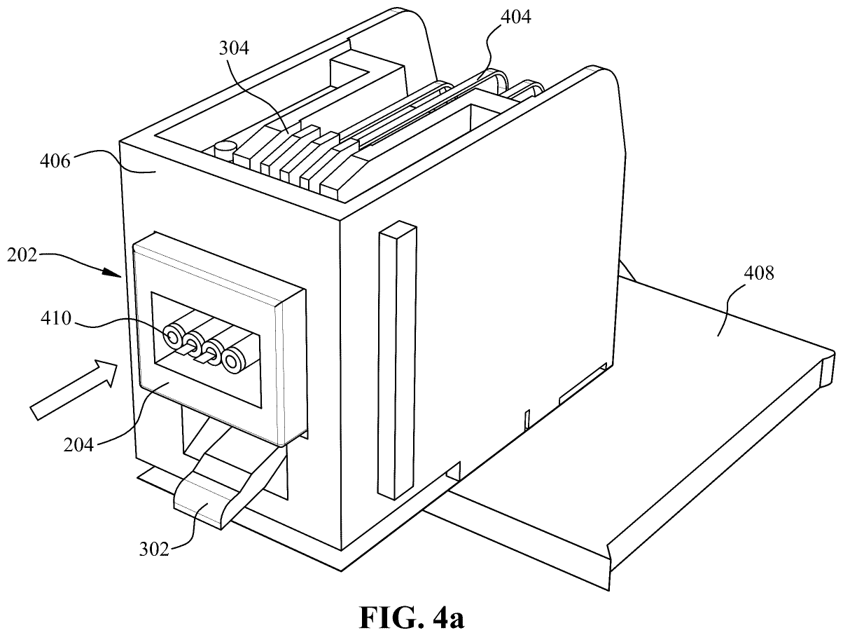

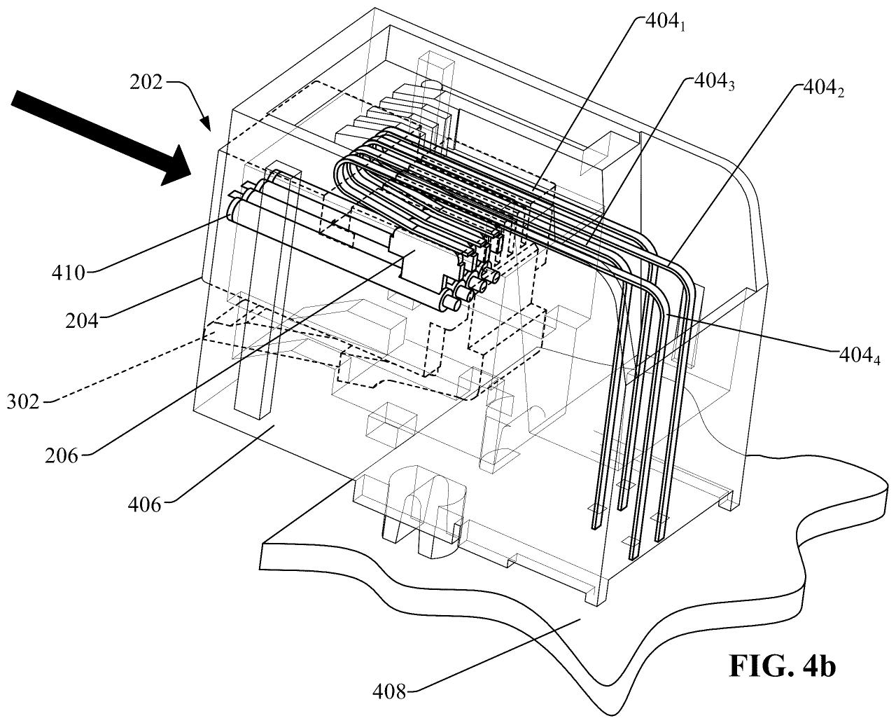

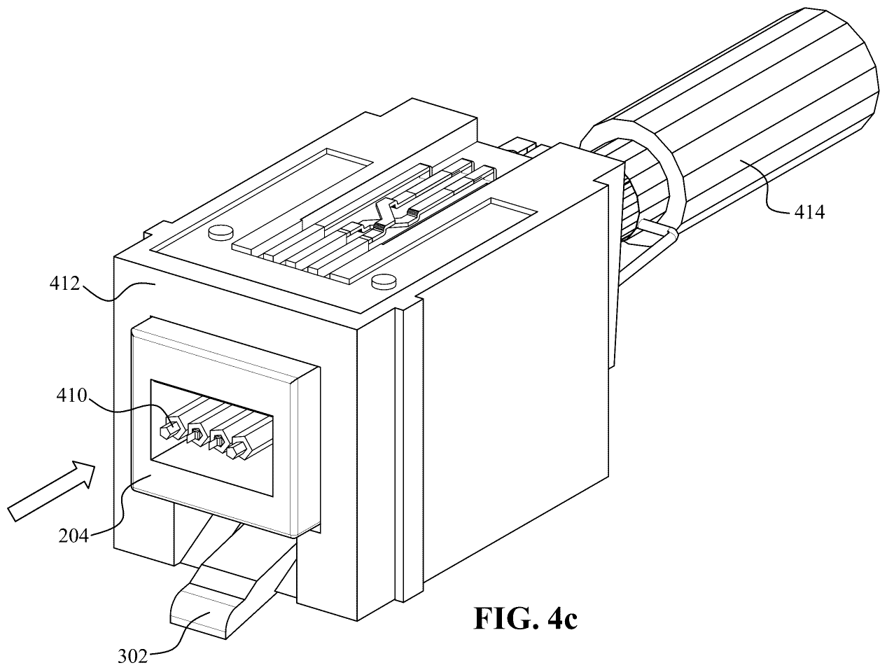

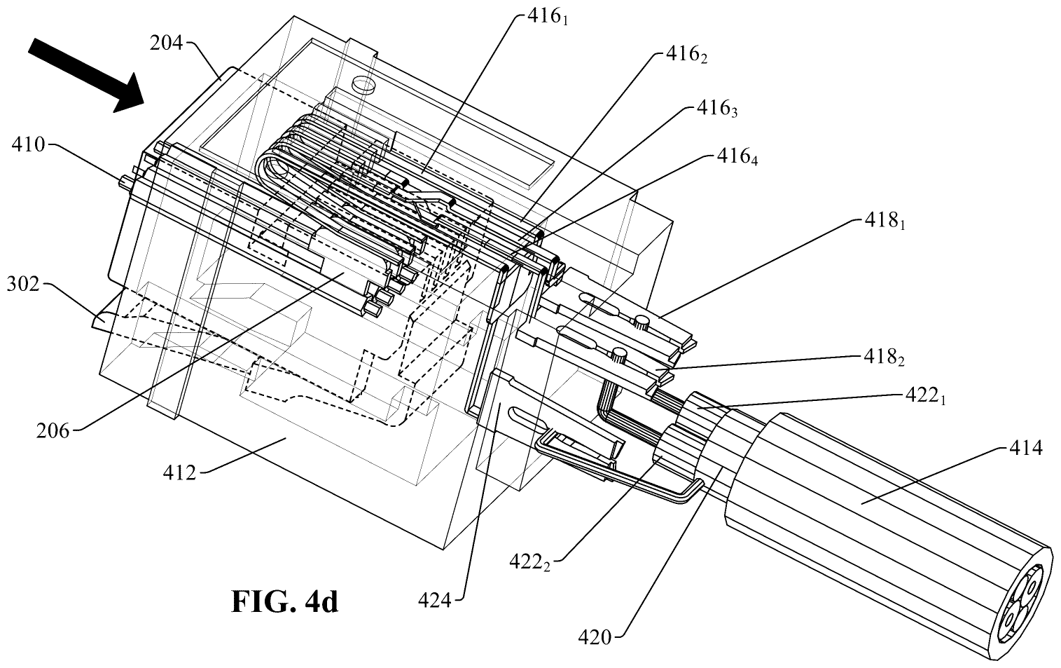

As can be seen in FIG. 3a, a flexible cantilevered latch 302 can be formed on the bottom of the connector body 204 of SPE plug 202 and is configured to engage with a corresponding latching mechanism formed within a mateable SPE jack while the SPE plug 202 is plugged into the SPE jack. Applying pressure to the latch 302 of the SPE plug disengages the latch 302 from the SPE jack's latching mechanism, allowing the SPE plug 202 to be removed from the SPE jack. As can be seen in FIG. 3b, the electrical contacts 206 of the SPE plug 202 reside within respective slots 304 formed on the top surface of the SPE plug's body 204. These slots 304 expose the contacts 206 of the SPE plug to corresponding electrically conductive tines within the SPE jack, such that the contacts 206 make electrical contact with the tines of the SPE jack (see, e.g., FIGS. 4a and 4b) while the SPE plug 202 is plugged into the SPE jack.

Embodiments of the SPE plug 202 can be used with various types of SPE jacks, such as printed circuit board (PCB) mountable jacks or cable jacks, to suit different types of connection scenarios. FIG. 4a is a perspective view of the SPE plug 202 inserted into a PCB mountable SPE jack 406. FIG. 4b is another view of the SPE plug 202 inserted into the PCB mountable SPE jack 406 with the jack's body made transparent to allow the internal electrical connections to be seen. In this example, SPE plug 202 may be terminated on the end of a shielded cable (not shown) comprising for conductors 410, which are respectively terminated to the SPE plug's electrical contacts 206. SPE jack 406 is mounted to a PCB 408 and contains electrically conductive tines 404 which connect to various circuits on the PCB 408. In some scenarios, SPE jack 406 may be one of multiple SPE jacks 406 of a patch panel or other multi-port device. Typically, it is when the PCB mounted SPE jack 406 is utilized in active electronic equipment, which has access to building ground and/or local system ground, that specific contacts within that jack 406 can be connected to system ground. The SPE plug 202 inserts into the mateable SPE jack 406 in the direction indicated by the arrows in FIG. 4a and FIG. 4b.

As noted above, the SPE plug's electrical contacts 206 (see FIG. 4b) reside within the slots 304 of the SPE plug's body 204. Within the SPE jack 406, a row of four electrically conductive tines 404₁-404₄ are arranged substantially in parallel with one another. When the SPE plug 202 is plugged into the SPE jack 406, the tines 404₁-404₄ of the SPE jack 406 make electrical contact with the SPE plug's four electrical contacts 206, respectively, through the slots 304 of the SPE plug's body 204.

To connect the two outermost contacts 206 of the SPE plug 202 (contacts 1 and 4 in FIG. 2) to system ground, the two corresponding outermost tines 404₁ and 404₄ of the SPE jack 406 can be electrically connected to system ground via electrically conductive circuit traces configured on the PCB (not shown in FIGS. 4a or 4b), or other suitable means, disposed within the body of the SPE jack 406. Thus, when the SPE plug 202 is plugged into the SPE jack 406, the SPE plug's two outermost contacts 1 and 4 are connected to system ground via the SPE jack tines 404₁ and 404₄. The two middle SPE jack tines 404₂ and 404₃, which make contact with the SPE plug's two signal contacts (contacts 3 and 4), convey the data signal between the cable and downstream systems or devices. The system ground may be connected to earth ground at one or more points within the system or, alternatively, may be independent from earth ground throughout the system. As used herein, the term “grounded” may refer to a contact or any other electrically conductive element, being electrically bonded to either an isolated system ground (e.g., a system ground that is not connected to earth ground at any point) or a system ground that does connect to earth ground at one or more points. The term “ground” or “grounded” as used herein can refers to either type of grounding arrangement.

FIG. 4c is a perspective view of the SPE plug 202 inserted into a cable-mountable SPE jack 412. FIG. 4d is another view of the SPE plug 202 inserted into the cable-mountable SPE jack 412 with the body of jack 412 made transparent to allow the internal electrical connections to be seen. In this example, the SPE jack 412 terminates the end of a shielded cable 414 comprising at least two signal conductors 422₁ and 422₂. In an example scenario, cable-mountable SPE jack 412 can be mounted in a patch panel or other multi-port device, and may be one of multiple such jacks 412 mounted in the panel or device. Jack 412 can be used within a channel to interconnect the cable 414 with another cable (not shown) terminated by the SPE plug 202.

In this cable-mountable example, a row of four electrically conductive tines 416₁-416₄ are arranged within the SPE jack 412. As in the PCB-mounted example, when the SPE plug 202 is plugged into the SPE jack 412, the tines 416₁-416₄ of the SPE jack 412 make electrical contact with the SPE plug's four electrical contacts 206, respectively. The two outermost contacts 206 of the SPE plug 202 (contacts 1 and 4 in FIG. 2) connect to the two corresponding outermost tines 416₁ and 416₄ of the SPE jack 406, which are in turn electrically connected to the jack's cable shield 420 via contact 424. Thus, when the SPE plug 202 is plugged into the SPE jack 412, the SPE plug's two outermost contacts 206 (contacts 1 and 4 in FIG. 2) are connected to the SPE jack tines 416₁ and 416₄ and therefore the shields of the cables, which terminate the SPE plug and SPE jack, are electrically connected together making this portion of the system ground circuit continuous through this connection, and the system ground may be carried through to any other down-stream plugs, jacks, cables, couples, or devices having properly configured system ground connections.

The two signal tines 416₂ and 416₃ of the SPE jack 412 are connected to respective two signal conductors 422₁ and 422₂ of the cable 414 via contacts 418₁ and 418₂ built into the jack 412. Thus, when the SPE plug 202 is plugged into the SPE jack 412, the two inner contacts 206 of the plug 204 (contacts 2 and 3 in FIG. 2) make contact with the corresponding two inner tines 416₂ and 416₃ of the SPE jack 412, thereby electrically connecting the signal contacts 206 of the plug 204—and their associated signal conductors 410—to the signal conductors 422₁ and 422₂ of the cable 414 via the contacts 418₁ and 418₂. The example SPE jack 412 illustrated in FIG. 4d depicts jack 412 as having a crossover configuration, whereby the two inner (signal) tines 416₂ and 416₃ are crossed. However, some embodiments of the cable-mounted SPE jack 412 can be configured for a passthrough signal connection in which the two inner tines 416₂ and 416₃ are not crossed.

The connectivity architectures illustrated in FIGS. 4a-4d are only intended to be exemplary, and it is to be appreciated that other suitable jack constructions that ground the two outermost contacts 206 (contacts 1 and 4) of the SPE plug 202, while passing the data signal carried on the two middle contacts 206, are also within the scope of one or more embodiments.

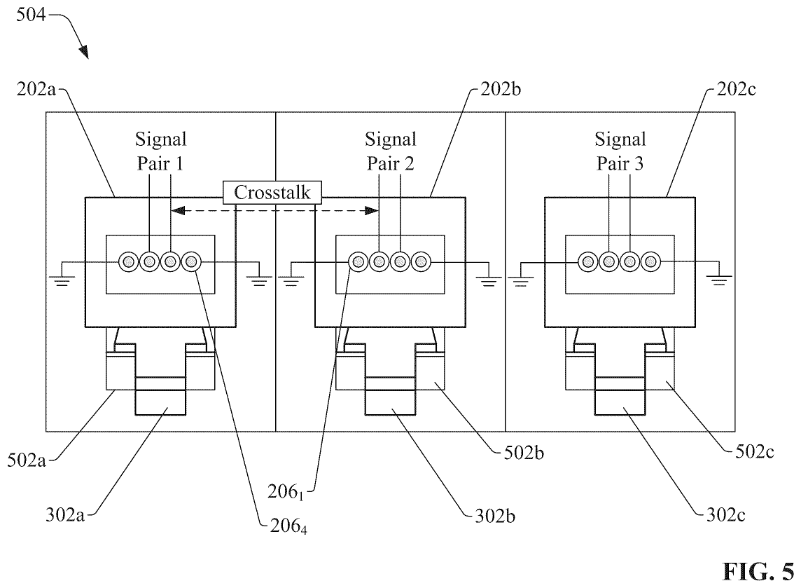

FIG. 5 is a front view of a portion of a patch panel 504 or other multi-port device in which three SPE plugs 202a-202c are plugged into three corresponding SPE jacks 502a-502c, which are arranged adjacent to one another. Jacks 502a-502c may conform to the design of either jack 406 or jack 412 described above or may have another structure capable of grounding the two outermost contacts 206 of the SPE plugs 202a-202c. From the perspective of this front view, the rear ends of the SPE plugs 202a-202c, and their associated wires are shown visible. Each of the SPE plugs 202a-202c will typically terminate a SPE cable to be interfaced with the patch panel 504; however, FIG. 5 omits the overall cables for clarity.

As described above in connection with FIG. 2-4d, the two outermost contacts 206 of each SPE plug 202 (the contacts 206 labeled with a system ground symbol in FIG. 5) can be connected to system ground via their connection to the two outermost tines 404₁ and 404₄ of their respective SPE jacks. The outermost contacts 206 of each SPE plug 202 may alternatively be connected to the system ground via the shield of their respective cable. The two middle contacts 206 of each SPE plug 202 (the contact pairs labeled “Signal Pair 1,” “Signal Pair 2,” and “Signal Pair 3” in FIG. 5) are connected to the signal conductors of their respective cables and carry data signals.

When typical SPE plugs or typical SPE jacks with no overall shielding or other means of external noise suppression are in proximity to one another, there is a high risk of alien crosstalk between signal pairs in adjacent, or otherwise proximate, SPE connectors, whereby electromagnetic noise or interference generated by one signal pair, in one connector, radiates to, and negatively impacts, the data signal carried by other nearby connectors. Without mitigation, crosstalk between signal pairs in proximate data connectors or electrical interference between a signal pair and other outside electrical sources can introduce errors in the data carried by the signal pairs.

The design of the SPE plug 202 and SPE jack (e.g., jacks 406 and 412) described herein can at least partially suppress crosstalk between pairs in connectors which are proximate to one another, since the outer most contacts of each SPE plug 202 and each SPE jack acts as a partial shield that inhibits noise between pairs in proximate SPE connectors. In the example depicted in FIG. 5, the contacts connected to system ground, contact 206₄ of SPE plug 202a and contact 206₁ of SPE plug 202b—which are positioned between Signal Pair 1 and Signal Pair 2—provide paths to system ground between the signal pairs in adjacent connectors that absorbs at least some of the electromagnetic noise that radiates from the signal pair contacts in each of the two connectors 202a and 202b, preventing noise radiated by either of the two signal pairs from interfering with the other signal pair. This contact arrangement in both individual SPE plug and SPE jack can also suppress unwanted electrical noise originating from other external electrical noise sources from entering the signal pairs residing in both the plug and jack.

Similarly, the tines 404₁ and 404₄ within SPE jacks 502 (see FIGS. 4a-4d), which are connected to the outer contacts 206₄ and 206₁ of the SPE plugs 202a and 202b, and which are also connected to system ground, act in a similar manner to absorb at least some of the electromagnetic noise that radiates from the single pair within any adjacent or otherwise proximate connectors.

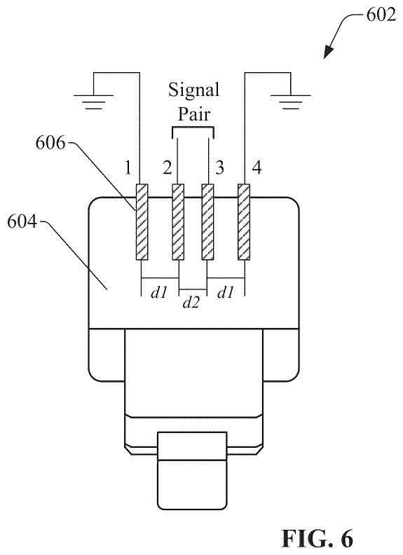

In some embodiments, rather than designing the SPE plug 202 such that the four contacts 206 are spaced equally by a distance d, as illustrated in FIG. 2, the spacing between adjacent contacts 206 can be varied across the row of contacts 206 to improve or substantially optimize impedance matching within the connector 202. FIG. 6 is a top view of an example SPE plug 602 having varied contact spacings according to one or more embodiments. Similar to connector 202 depicted in FIG. 6, SPE plug 602 comprises a connector body 604 within which are mounted four electrically conductive contacts 606. The two outermost contacts 606—contacts 1 and 4—are configured to be grounded while plugged into a corresponding SPE jack (e.g., via connection with corresponding grounded tines 404₁, 404₄ within the SPE jack), while the middle two contacts 606—contacts 2 and 3—pass the data signal carried by the cable on which the SPE plug 602 is terminated. Also similar to SPE plug 202, the two grounded contacts 1 and 4 may be connected to the shield or drain wire of the cable, may be shorted together within the SPE plug body 604, or may be connected to a shield within the mateable SPE jack (see, e.g., FIG. 4).

In contrast to SPE plug 202, the spacing between the two signal contacts 2 and 3 is different than the spacing between the first ground contact 1 and its adjacent signal contact 2, and between the second ground contact 4 and its adjacent signal contact 3. In the example illustrated in FIG. 6, each of the ground contacts 1 and 4 is spaced from its adjacent signal contact, 2 and 3, respectively, by a first distance d1, while the two signal contacts 2 and 3 are spaced from one another by a second distance d2, where distance d2 is smaller than distance d1. In an example implementation, distance d1 may be 50 mils while distance d2 may be 60 mils. Other spacings are also within the scope of one or more embodiments. Optimum values for d1 and d2 can be determined by first establishing the various impedance values of the SPE cable and then using a simulation tool to determine the spacings d1 and d2 for the SPE plug that allow the connector impedance to match these. Optimum values may also be determined through trial and error, or a combination of simulation tool and trial and error. Alternatively, a set value for cable and connector impedances may be pre-established, and then both the cable and the connectors can be designed using simulation tools and/or trial and error to target these specific values

The amount of coupling, or energy transfer, between adjacent contacts 606 is a function of the distance between the contacts 606. The varied contact spacings depicted in FIG. 6 can improve the return loss of the data signal through the SPE plug 602 by yielding couplings between the contacts 606 that more closely resemble the couplings that exist between the signal conductors and shield of the data cable, thereby matching or substantially matching the signal-to-signal impedances of the SPE plug 602 and the cable to which SPE plug 602 is terminated, as well as the signal-to-shield impedances of the SPE plug 602 and the cable. That is, the spacings d1 and d2 can be selected such that the impedance of the signal contacts 2 and 3 (also referred to as the tip-to-ring impedance), which is a function of the coupling between those contacts, substantially matches the impedance of the signal conductors of the cable terminated by the SPE plug 602. The spacings d1 and d2 can also be selected such that the impedance of contacts 1 and 2 (also referred to as the tip-to-ground impedance) substantially matches the impedance of the cable's first signal conductor and shield, and the impedance of contacts 3 and 4 (also referred to as the ring-to-ground impedance) substantially matches the impedance of the cable's second signal conductor and shield. Matching the impedances of the SPE plug 602 and the cable in this manner can prevent loss of signal power due to return loss of the signal through the connector 606.

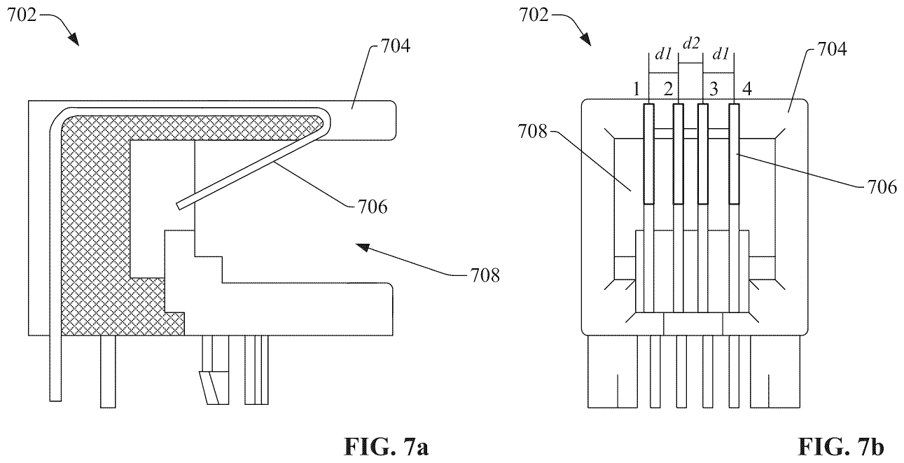

FIGS. 7a and 7b are a side view and a front view, respectively, of an example SPE jack 702 designed to accommodate the SPE plug 602. SPE jack 704 comprises a receptacle 708 within a SPE jack body 704, within which are mounted four electrically conductive tines 706 corresponding to the four contacts 606 of SPE plug 602. These tines 706 make electrical contact with their corresponding contacts 606 when the SPE plug 602 is inserted into the receptacle 708. SPE jack 702 can have a design substantially similar to that of SPE jack 406 described above in connection with FIGS. 4a and 4b. However, to accommodate SPE plugs 602 having the varied contact spacings depicted in FIG. 6, the tines 706 of the SPE jack 702 can be similarly spaced such that the two middle tines (tines 2 and 3) are spaced by a distance d2, and the spacing between each outer tine and its adjacent tine (that is, the spacing between tine 1 and 2 and between tine 3 and 4) is d1. Similar to the SPE jack 406 depicted in FIGS. 4a and 4b, the two outermost tines 1 and 4 can be grounded via connection to a grounded structure within the SPE jack 702, within the device that houses the SPE jack 702, or on a circuit board on which the SPE jack 702 is mounted. The cable-mounted SPE jack 412 depicted in FIGS. 4c and 4d can also be adapted for use with SPE plug 602 by spacing the tines 416 accordingly.

Furthermore, the SPE jack 406 or the SPE jack 702 may be designed such that their individual impedances match the individual impedances of the SPE plug 702, which has been designed to match the individual impedances of the cable. As with plug 702, this may be achieved by varying the distances between the tines within the jacks.

The improved impedance matching between the SPE plug 602 and a cable terminated by the SPE plug 602, achieved by suitably selected spacings d1 and d2, can improve the return loss of the signal through the SPE plug 602, thereby improving power transfer through the SPE plug 602 relative to connectors with equally spaced contacts. Similarly, the improved impedance matching between the SPE jacks 406 and 702, and with the SPE plug 602, can improve the return loss of the signal through these connectors, thereby improving power transfer through the SPE plug 602 and jack 406 or 702 relative to connectors having equally spaced contacts. The improved power transfer between the cable and the SPE plug 602, and the SPE jacks 406 or SPE jack 702, together with the reduced alien crosstalk achieved by grounding the two outer contacts 1 and 4, can improve overall SPE signal integrity through these SPE connector and cable relative to cable and other SPE connectors and cable.

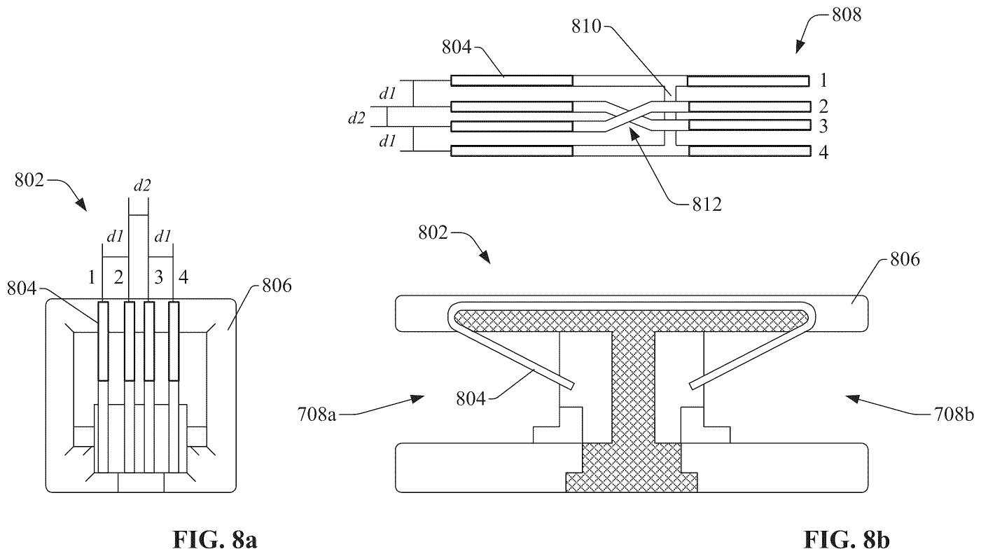

FIGS. 8a and 8b are an end view and a side view, respectively, of one example of an back-to-back SPE coupler 802 that can be used to communicatively couple two SPE plugs 602. SPE coupler 802 comprises two opposing receptacles 708a and 708b formed in respective ends of an elongated contact lead frame 806. Four electrically conductive tines 804, corresponding to the four contacts 606 of SPE plug 602, make up the contact lead frame 806 such that the two ends of each tine 804 are exposed within the receptacles 708a and 708b, respectively. In this way, each tine 804 forms an electrically conductive path between the two receptacles 708a and 708b.

Two SPE cables can be electrically connected by terminating each cable with an SPE plug 602 and inserting each SPE plug 602 into one of the receptacles 708a and 708b. While the SPE plugs 602 are plugged into the receptacles 708a and 708b, the SPE coupler's tines 804 make electrical contact with the corresponding contacts 606 in the SPE plugs 602, thus electrically connecting the signal pair of one cable with the signal pair of the other cable via tines 2 and 3, while also connecting the outer ground contacts of the two SPE plugs 602 via tines 1 and 4. As shown in the top view 808 of the SPE coupler's tines 804, the two outermost tines 1 and 4, corresponding to the ground contacts 1 and 4 of the SPE plug 602, can be electrically shorted together via connection 810, which is a portion of the contact lead frame 806.

In the illustrated example, the signal tines 2 and 3 exchange positions between the first receptacle 708a and the second receptacle 708b (at crossover point 812), yielding a crossover configuration. However, other embodiments of the SPE coupler 802 may be configured to act as a pass-through SPE coupler whereby the signal tines 2 and 3 do not exchange positions between the receptacles 708a and 708b.

The tines 804 of the example SPE coupler 802 are spaced to accommodate the spacings d1 and d2 of the SPE plug 602. While in this example this spacing is maintained throughout the coupler, similarly to how the spacing between the tines of SPE jack 706 and SPE jacks 702 can be adjusted within areas of their tines which do not need to accommodate the contacts of the plug, the spacing between the tines within the coupler can be adjusted in these similar areas, to match the match the impedances of the plug 602.

Furthermore, while the example SPE coupler 802 is shown with tine spacing to accommodate SPE plug 602, an SPE coupler may be designed to accommodate SPE plug 202. Regardless of the tine spacing of the coupler, like the SPE jacks 406 and 702, the outer most tines of both couplers are connected to system ground thereby providing the same type of improvement in transmission performance seen in the SPE jacks.

The various SPE connector embodiments described herein can improve overall signal integrity through the connector by blocking at least a portion of alien crosstalk between adjacent or otherwise proximate connectors. This is achieved by simple means of grounding the outermost contacts on either side of the SPE signal pair, creating a path to ground that absorbs radiant energy from the signal pair before that energy can interfere with adjacent or otherwise proximate signal pairs. Signal integrity can be further improved in some embodiments by substantially optimizing impedance matching between the connector and its associated cable, as achieved by selecting suitable spacings between adjacent connector contacts.

Although the example connectors described herein have been SPE connectors comprising a single signal pair, the crosstalk suppression and contact spacing techniques described herein can be applied to other types of connectors, including connectors comprising more than one signal pair. In such embodiments, the connector may comprise more than four contacts, with the two outermost contacts being grounded to suppress crosstalk between adjacent or otherwise proximate connectors.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A connector, comprising:
a connector body; and
electrical contacts mounted in the connector body and configured to contact corresponding tines within a jack while the connector is plugged into the jack,
wherein
two outermost contacts of the electrical contacts are connected to ground while the connector is plugged into the jack.

2. The connector of claim 1, wherein the two outermost contacts are configured to make electrical contact with respective two tines, of the tines within the jack, that are connected to a grounding structure within the jack.

3. The connector of claim 1, wherein at least two middle contacts, of the electrical contacts, positioned between the two outermost contacts are configured to pass a data signal between the jack and a cable terminated by the connector.

4. The connector of claim 3, wherein a first distance between the two inner contacts is different than a second distance between one of the outermost contacts and an adjacent one of the at least two middle contacts.

5. The connector of claim 4, wherein the first distance and the second distance yield a matched impedance or a substantially matched impedance between the connector and the cable.

6. The connector of claim 4, wherein the first distance is smaller than the second distance.

7. The connector of claim 3, wherein while the connector is plugged into the jack, the two outermost contacts create a path to ground that suppresses at least a portion of alien crosstalk between the connector and an adjacent or proximate connector.

8. The connector of claim 1, wherein the connector is a single pair ethernet connector.

9. A connector, comprising:
a connector body; and
electrical contacts mounted in the connector body and configured to contact corresponding tines within an outlet while the connector is plugged into the outlet,
wherein
the electrical contacts comprise two outermost contacts and two middle contacts positioned between the two outermost contacts, and
a first distance between the two middle contacts is different than a second distance between one of the outermost contacts and an adjacent one of the two middle contacts.

10. The connector of claim 9, wherein the first distance and the second distance yield a signal-to-signal impedance of the connector that substantially matches a signal-to-signal impedance of a cable terminated by the connector.

11. The connector of claim 9, wherein the first distance and the second distance yield a signal-to-ground impedance of the connector that substantially matches a signal-to-ground impedance of the cable.

12. The connector of claim 9, wherein the first distance is smaller than the second distance.

13. The connector of claim 9, wherein the two middle contacts are configured to pass a data signal between the outlet and a cable terminated by the connector.

14. The connector of claim 9, wherein the two outermost contacts are grounded while the connector is plugged into the outlet.

15. The connector of claim 14, wherein the two outermost contacts are configured to make electrical contact with respective two tines, of the tines within the outlet, that are connected to a grounding structure within the outlet.

16. The connector of claim 14, wherein while the connector is plugged into the outlet, the two outermost contacts create a path to ground that suppresses at least a portion of alien crosstalk between the connector and an adjacent or proximate connector.

17. The connector of claim 9, wherein the connector is a single pair ethernet connector.

18. A connector, comprising:
a connector body; and
a row of electrical contacts mounted in the connector body, wherein the row of electrical contacts comprises:
two outermost contacts that connect to ground while the connector is plugged into a jack, and
two signal contacts between the two outermost electrical contacts.

19. The connector of claim 18, wherein the two outermost contacts are at least one of connected together inside the connector body or connected to a shield of the connector body.

20. The connector of claim 18, wherein a first distance between the two signal contacts is different than a second distance between one of the outermost contacts and an adjacent one of the two signal contacts.
